(19) United States
(12) Patent Application Publication
(10) Pub. No.: US 2006/0017195 A1
(43) Pub. Date: Jan. 26, 2006

(54) Method for injection molding a solid pattern onto a shoe upper

(76) Inventor: Deng-Reng Yang, Taichung County (TW)

Correspondence Address: CHARLES E. BAXLEY, ESQ., 90 JOHN STREET, THIRD FLOOR, NEW YORK, NY, 10038, US

(21) Appl. No.: 10/897,920

(22) Filed: Jul. 24, 2004

(51) Int. Cl. B29D 31/50

(52) U.S. Cl. 264/244

(57) ABSTRACT

The invention relates to a method for injection molding a solid pattern onto a shoe upper, which is capable of molding solid pattern on a shoe upper, and generally including the following steps: 1. shoe upper stretching process 2. tightening a lower periphery of the shoe upper material 3. upper mold pressing process 4. injection molding process 5. cleaning up the final product.

### BACKGROUND OF THE INVENTION

1. Field of the Invention

This invention relates to a method for injection molding a solid pattern onto a shoe upper, which is capable of overcoming the defect of the prior art that it is unable to molding solid pattern on a shoe upper, which includes the following steps: 1. shoe upper stretching process 2. tightening a lower periphery of the shoe upper material 3. upper mold pressing process 4. injection molding process 5. cleaning up the final product.

2. Description of the Prior Arts

Existing plastic injection molding technology is unable to mold solid pattern onto leather or fabric shoe upper directly, and the defects of the existing plastic injection molding methods are to be explained as follows:

First, the existing technology is unable to stretch the leather or the fabric shoe upper tight enough, the technology of prior art is still at the research stage, which greatly limits diversity of the appearance and the function of the shoe products.

Second, if the conventional method is used to mold plastic onto the shoe upper, since many production equipments are involved, it is impossible for the operator to check all the details. The surface of the shoe upper is likely draped, in this case, not only the injection-molding pattern is failed, but also the appearance of the shoes will be ugly.

The present invention has arisen to mitigate and/or obviate the afore-described disadvantages.

### SUMMARY OF THE INVENTION

The primary object of the present invention is to provide a method for injection molding a solid pattern onto a shoe upper, which is capable of overcoming the defect of the prior art, and generally including the following steps: 1. shoe upper stretching process 2. tightening a lower periphery of the shoe upper material 3. upper mold pressing process 4. injection molding process 5. cleaning up the final product.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a flow chart in accordance with the present invention for showing the steps of injection molding a solid pattern onto a shoe upper;

FIG. 2 shows the shoe upper is place on the last;

FIG. 3 shows the shoe upper is being stretched on the last;

FIG. 4 shows a lower periphery of the shoe upper is being stretched and tightened;

FIG. 5 shows the upper mold is pressing down;

FIG. 6 is a cross sectional view of a final product in accordance with the present invention.

### DETAILED DESCRIPTION OF THE PREFERRED EMBODIMENT

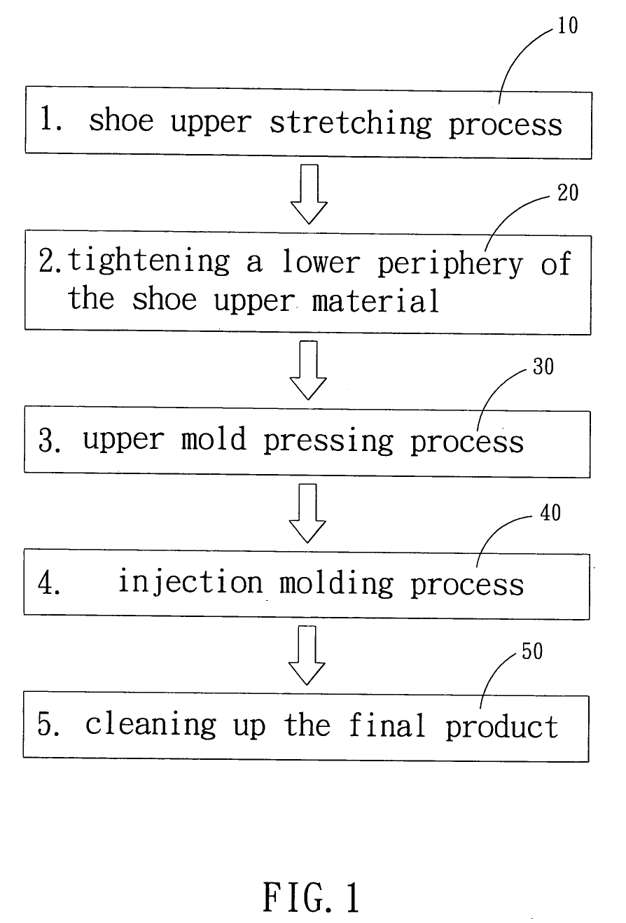

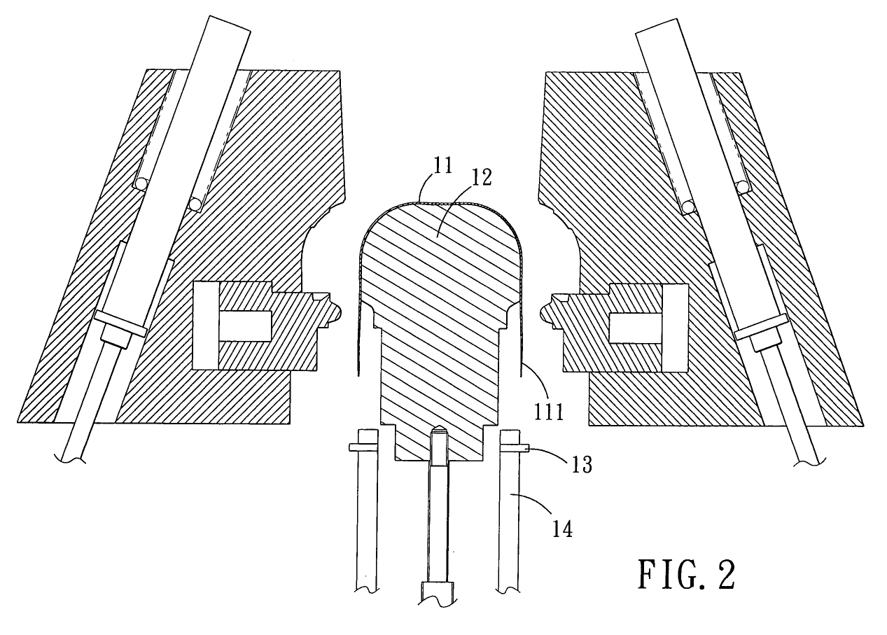

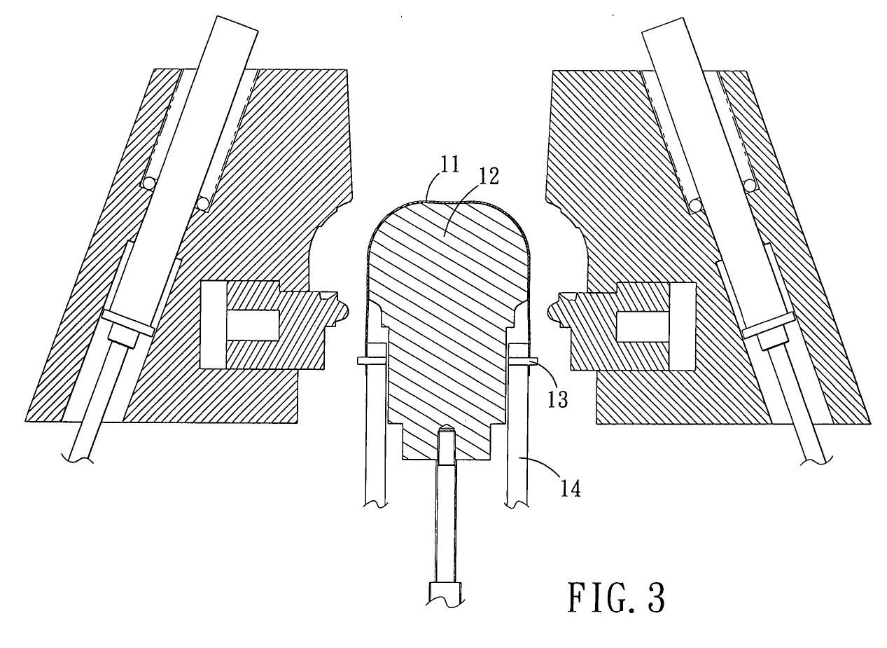

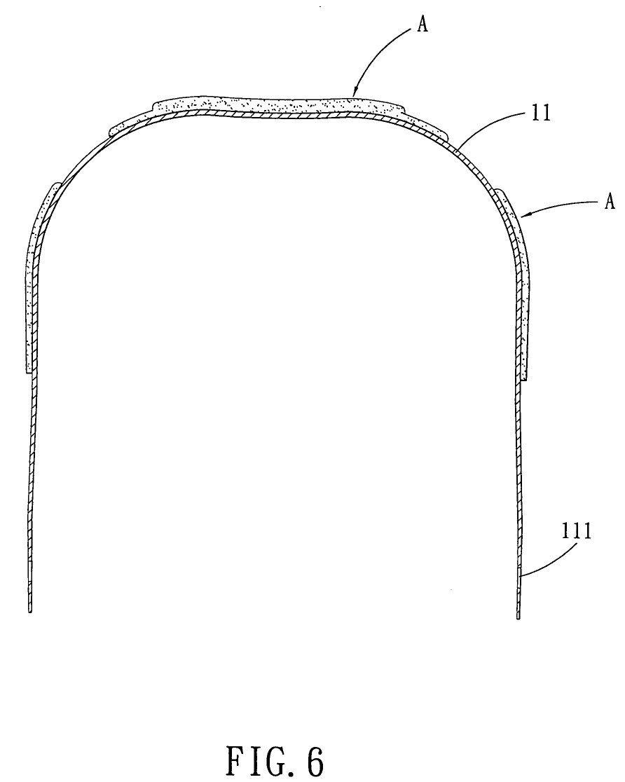

A method for injection molding a solid pattern onto a shoe upper in accordance with a preferred embodiment of the present invention is shown in FIGS. 1-6, which generally includes the following steps (the shoe upper material in this embodiment is leather):

First, shoe upper stretching process 10: with reference to FIGS. 1-3, initially, the worker has to made a plurality of positioning apertures 111 on the periphery of a leather material 11 (or fabric), and placing the leather material 11 (or fabric material) on a last 12. After that, plural pins 13 of stretching rod 14 are inserted in the respective positioning apertures 111 of the leather material 11 which is to be tightly stretched by the extendable stretching rod 14, so that the leather material 11 is enabled to abut closely on the last 12.

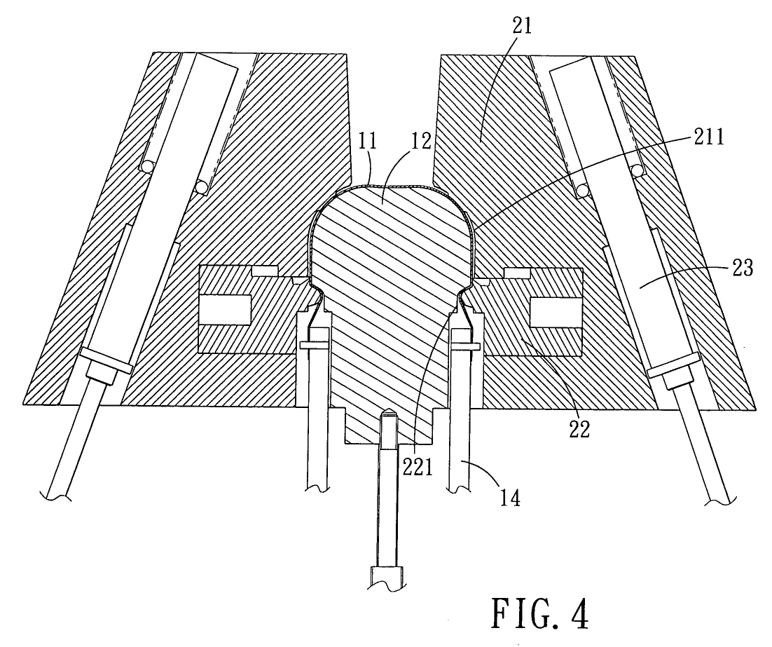

Second, process 20 for tightening the lower periphery of the leather: with reference to FIG. 4, after the leather material 11 is stretched by the stretching rod 14, plural oblique leaders 23 are employed to move a pair of outer sliding blocks 21 having cavities 211 inwardly towards the leather material 11. At the start of the moment, an extendable stretching mold 22 at the lower periphery of the respective outer sliding blocks 21 stretches out to push the lower periphery of the leather 11 inward and make it tight. The last 12 is provided with grooves 221 corresponding to the stretching mold 22, which is designed to enable the leather material 11 to abut tightly against the last 12.

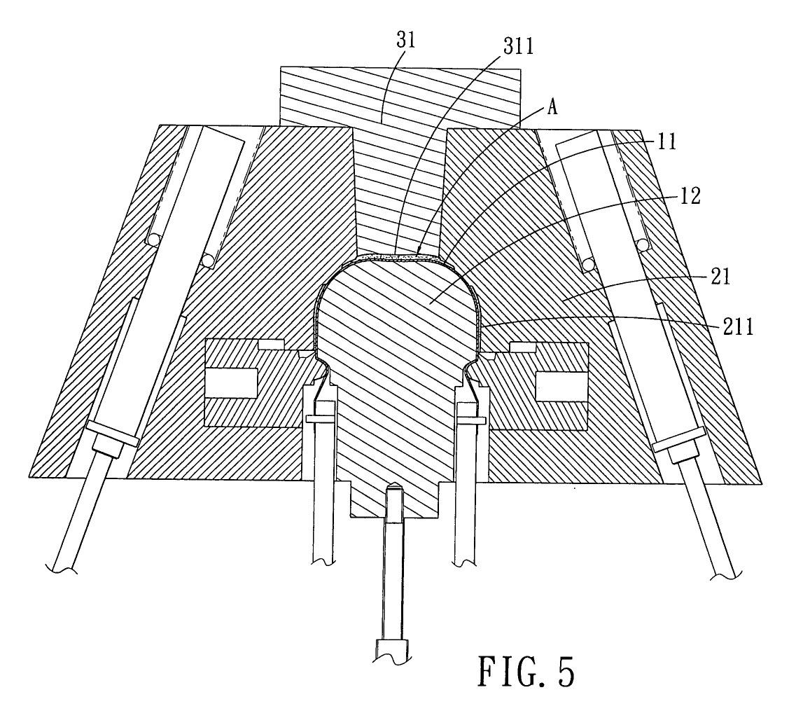

Third, upper mold pressing process 30, as shown in FIG. 5, pressing an upper mold 31 having a cavity 311 on the surface of the leather material 11.

Fourth, injection molding process 40: as shown in FIG. 5, in this process, the injection molding machine injects injecting molding material A into the cavities 211 of the outer sliding blocks 21 and the cavity 311 of the upper mold 31, respectively. Since the leather material 11 has been tightened, the material A can be integrally and firmly molded onto the surface of the leather material 11, and creating a solid pattern.

Fifth, process 50 for cleaning up the final product: after being taken out of the mold, the surface of the leather material 11 is molded with the injection molding material A that corresponds to the cavities 211 of the outer sliding blocks 21 and the cavity 311 of the upper mold 31.

The shoe upper stretching process 10 and the process 20 for stretching the lower periphery of the leather material 11 are able to stretch tight and position the lower periphery of the leather material 11 by employing the stretching rods 14. Furthermore, the moveable stretching molds 22 is able to inwardly tighten the lower periphery of the leather material 11. Thus, the leather material 11 is able to form a flat surface corresponding to the last 12, so that the injection molding material A is firmly molded onto the surface of the leather material 11 in a 3-D manner.

It is to be noted that the outer sliding blocks 21 and the upper mold 31 are well known in the prior art and are not limited to the shapes described above. The effect of the present invention is only achievable with the stretching molds 22. And other molding technologies are known in the art. In addition, the last 12 is movable and extendable so as to enhance the tightening effect of the shoe upper.

While we have shown and described various embodiments in accordance with the present invention, it should be clear to those skilled in the art that further embodiments may be made without departing from the scope of the present invention.

What is claimed is:

1. A method for injection molding solid pattern on a shoe upper comprising the following steps:
first, shoe upper stretching process: forming a plurality of positioning apertures on an periphery of a shoe upper material, placing the shoe upper material on a last, and then stretching the shoe upper material downward;
second, tightening a lower periphery of the shoe upper material: after the shoe upper being stretched the stretching rod, plural sliding blocks moving towards the shoe upper material, an extendable stretching mold pushing the lower periphery of the shoe upper material inward, and thus tightening the shoe upper material;
third, upper mold pressing process: pressing an upper mold having a cavity on a surface of the shoe upper material;
fourth, injection molding process: injecting material into the cavity of the upper mold by employing an injection molding machine, since the shoe upper material has been tightened, the injection-molding material is integrally and firmly molded onto the surface of the shoe upper material;
fifth, cleaning up the final product: after being taken out of the mold, the surface of the shoe upper material is injection molded with the injection molding material that corresponds to the cavity of the upper mold.

2. The method for injection molding a solid pattern onto a shoe upper as claimed in claim 1, wherein the shoe upper material is leather.

3. The method for injection molding a solid pattern onto a shoe upper as claimed in claim 1, wherein the shoe upper material is fabric.

4. The method for injection molding a solid pattern onto a shoe upper as claimed in claim 1, wherein the outer sliding blocks are provided with cavities, and the injection molding machine is employed to inject the injection molding material into cavities of the outer sliding blocks and to make it into solid plastic material.

5. The method for injection molding a solid pattern onto a shoe upper as claimed in claim 1, wherein the stretching mold is moved by the outer sliding blocks when tightening the lower periphery of the shoe upper material.

6. The method for injection molding a solid pattern onto a shoe upper as claimed in claim 1, in the shoe upper stretching process, the lower periphery of the shoe upper material is stretched by employing a plurality of extendable stretching rods to pull the positioning apertures on the periphery of a shoe upper material.

7. The method for injection molding a solid pattern onto a shoe upper as claimed in claim 1, wherein the last is movable and extendable, which is used to enhance tightening effect of the shoe upper.
